(19) United States
(12) Patent Application Publication
(10) Pub. No.: US 2006/0273502 A1
(43) Pub. Date: Dec. 7, 2006

(54) Fence panel

(76) Inventors: Amir Sade, Kibbutz Ramat Yochanan (IL); Amir Sliper, Kibbutz Ramat Yochanan (IL); Yishai Knoll, Ramat Yishai (IL)

Correspondence Address: ABELMAN, FRAYNE & SCHWAB, 666 THIRD AVENUE, 10TH FLOOR, NEW YORK, NY, 10017, US

(21) Appl. No.: 11/351,033

(22) Filed: Feb. 8, 2006

Related U.S. Application Data
(60) Provisional application No. 60/651,431, filed on Feb. 8, 2005.

(51) Int. Cl. B25B 1/20

(52) U.S. Cl. 269/41

(57) ABSTRACT

The present invention seeks to provide a fence including a plurality of corrugated plastic, integrally formed fence panels and a plurality of rectangular frames, each surrounding a corresponding single one of the plurality of fence panels.

### REFERENCE TO RELATED APPLICATIONS

Reference is made to U.S. Provisional Patent Application 60/651,431, filed Feb. 8, 2005, entitled “PRIVACY FENCE”, the disclosure of which is hereby incorporated by reference and priority of which is hereby claimed pursuant to 37 CFR 1.78(a) (4) and (5)(i).

### FIELD OF THE INVENTION

The present invention relates to fences, and more specifically to designed privacy fences.

### BACKGROUND OF THE INVENTION

The following publications are believed to represent the current state of the art: U.S. Pat. Nos. 6,637,728; 6,601,831; 6,398,193; 5,529,289.

### SUMMARY OF THE INVENTION

The present invention seeks to provide an improved fence.

There is thus provided in accordance with a preferred embodiment of the present invention a fence including a plurality of corrugated plastic, integrally formed fence panels and a plurality of rectangular frames, each surrounding a corresponding single one of the plurality of fence panels.

In accordance with a preferred embodiment of the present invention each of the fence panels has a width dimension in the range of 3 to 6 feet. Preferably, each of the fence panels has a height dimension in the range of 1 to 20 feet.

In accordance with another preferred embodiment of the present invention each of the fence panels has a width dimension and a height dimension, a ratio of the height dimension and the width dimension being less than 2:1. Preferably, each of the frames includes at least one elongate panel mount.

### BRIEF DESCRIPTION OF THE DRAWINGS

The present invention will be understood and appreciated more fully from the following detailed description, taken in conjunction with the drawings in which:

FIGS. 1A and 1B are a simplified exploded view illustration and a pictorial illustration of a single fence plate, constructed and operative in accordance with a preferred embodiment of the present invention, framed by a fence frame thereby to form a fence panel;

FIG. 2 is a sectional illustration of the panel of FIGS. 1A and 1B, taken along section lines II-II in FIG. 1B;

FIG. 3 is a pictorial illustration of a fence constructed of a plurality of the panels of FIGS. 1A-2;

FIGS. 4A and 4B are a simplified exploded view illustration and a pictorial illustration of a single fence plate, constructed and operative in accordance with another preferred embodiment of the present invention, framed by a fence frame thereby to form a fence panel;

FIG. 5 is a sectional illustration of the panel of FIGS. 4A and 4B, taken along section lines V-V in FIG. 4B; and

FIG. 6 is a pictorial illustration of a fence constructed of a plurality of the panels of FIGS. 4A-6.

### DETAILED DESCRIPTION OF A PREFERRED EMBODIMENT

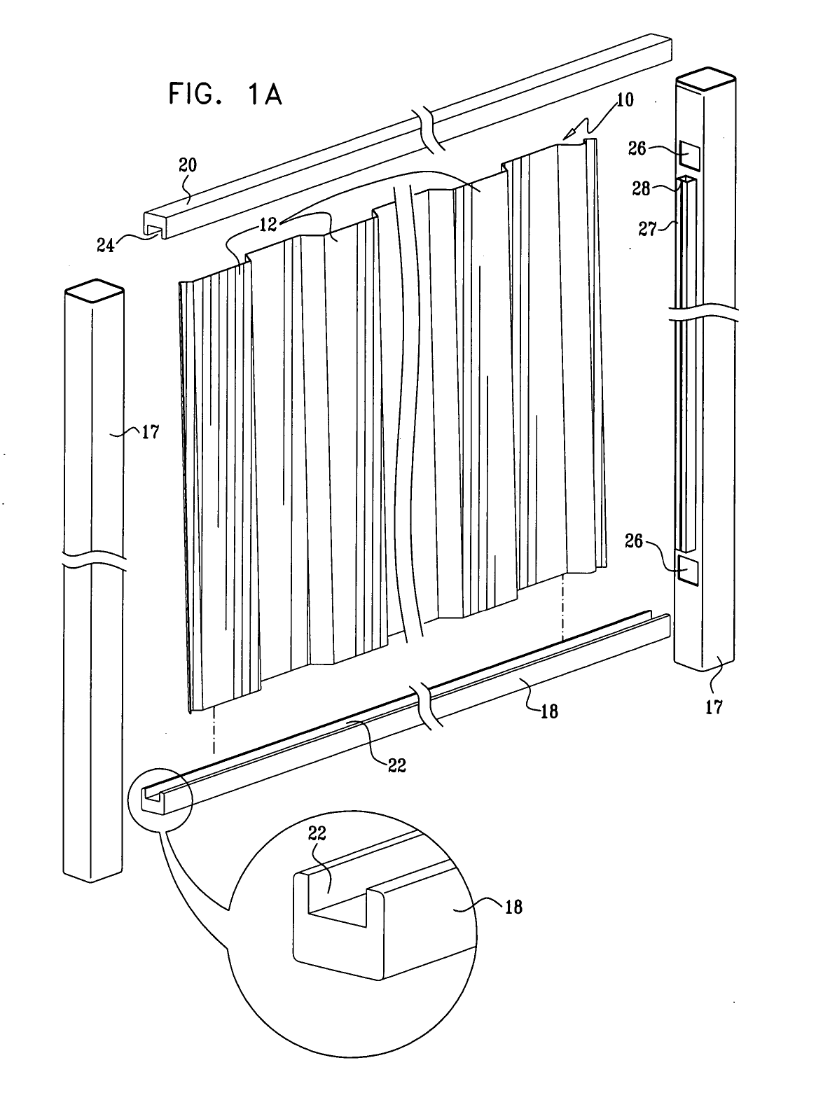

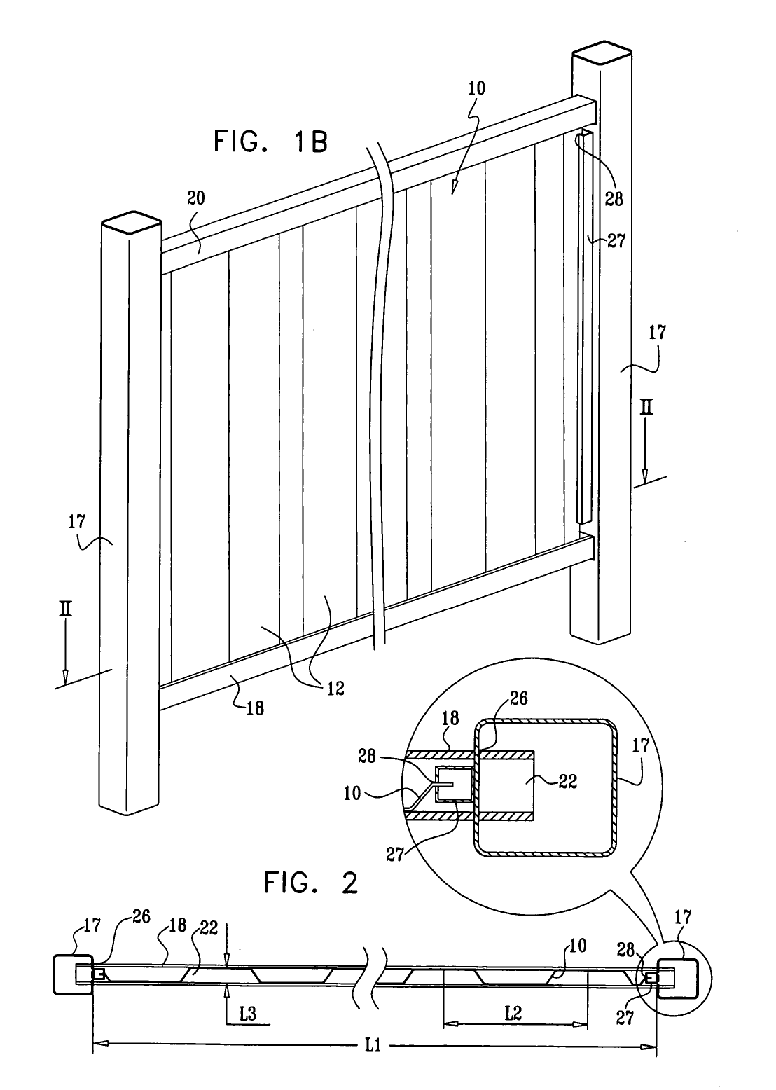

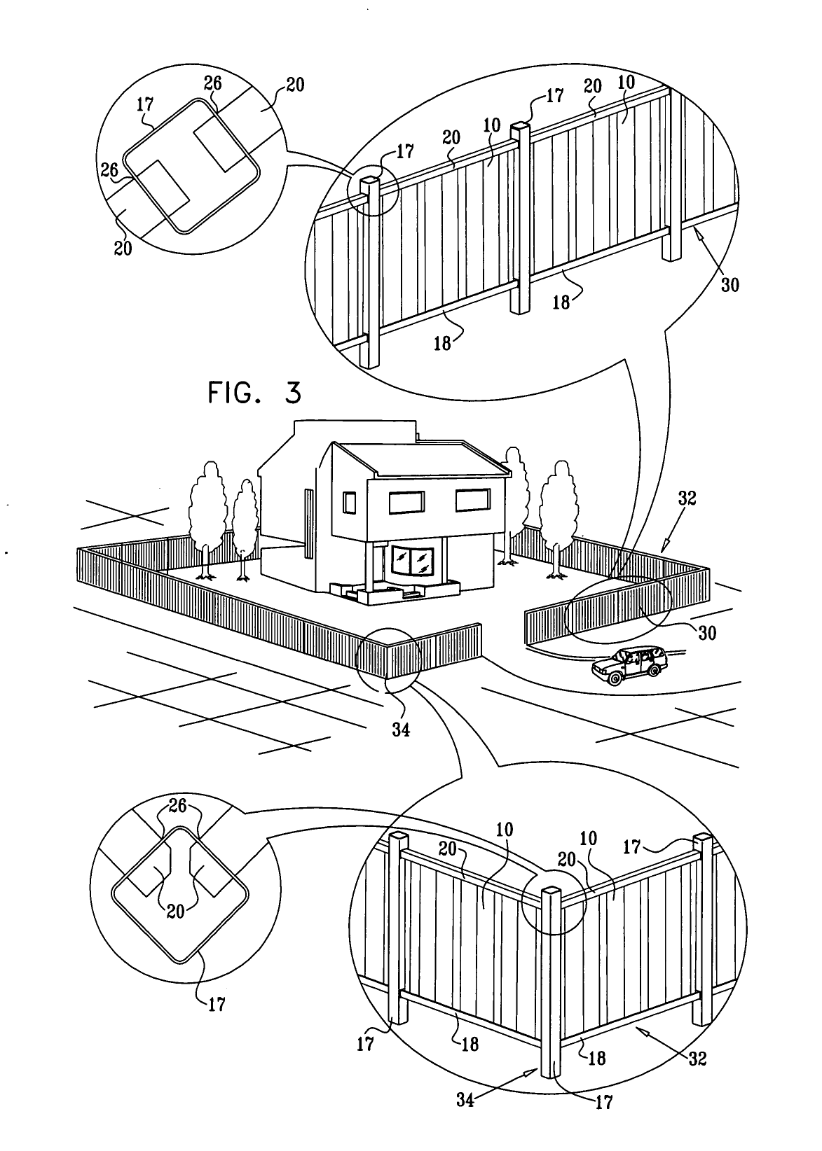

Reference is now made to FIGS. 1A and 1B, which are a simplified exploded view illustration and a pictorial illustration of a single fence plate, constructed and operative in accordance with a preferred embodiment of the present invention, framed by a fence frame thereby to form a fence panel, to FIG. 2, which is a sectional illustration of the panel of FIGS. 1A and 1B, and to FIG. 3, which is a pictorial illustration of a fence constructed of a plurality of the panels of FIGS. 1A-2.

As seen in FIGS. 1A-3, an integrally formed fence plate 10, preferably formed of a single layer of corrugated PVC, is formed with a plurality of ridges 12, thereby providing an aesthetic look of a picket fence. Alternatively, the fence plate 10 may be formed of polycarbonate or any other suitable plastic material.

The fence plate 10 is preferably surrounded by a fence frame formed of a plurality of beams which provide strength to the fence. The beams may be solid or hollow, and may be square, or formed in any other suitable polygonal shape.

The fence frame is preferably formed of two connector beams 17, a base beam 18 and a top beam 20 all made of PVC, such as a frame of fence model no. 20972 commercially available from U.S. Fence Inc. of Ohio USA. Alternatively, the connector beams 17, base beam 18 and top beam 20 may be formed of wood, metal, or any other suitable material.

As seen with particular clarity in FIG. 1A, base beam 18 includes a longitudinal groove 22, into which is seated a bottom side of the plate 10, in the sense of FIGS. 1A and 1B, and top beam 20 includes a longitudinal groove 24, which is mounted onto the top side of the plate 10, in the sense of FIGS. 1A and 1B. Each of the connector beams 17 includes one or more bores 26, which engage one or more of beams 18 and 20. Preferably, each connector beam 17 includes two bores 26, intermediate which is formed an elongate panel mount 27 including a notch 28, which engages one vertical side of plate 10, in the sense of FIGS. 1A and 1B.

FIG. 2 shows that each plate 10 is preferably of a length designated by L1, which is typically in the range of 3-6 feet, has a distance between ridges designated by L2, which is typically in the range of 11-12 inches, and has a profile height designated by L3, which is typically in the range of half an inch to one and a half inches. Preferably, the height of each plate 10 lies in the range of 1 to 20 feet and the ratio between the height and width of each plate 10 is less than 2:1.

As seen in FIG. 3, a single connector beam 17 may be used to connect two or more plates 10, each mounted within panel mounts 27 onto bottom beam 18 and having mounted thereon top beam 20. The top and bottom beams are placed in bores 26 at various angles. FIG. 3 shows the connection between connector beam 17 and two plates 10 along a wall 30 of a fence 32 formed around a building, as well as the connection between connector beam 17 and two plates 10 at a corner 34 of fence 32.

It is appreciated that the fence may be formed in any suitable color or of any suitable material, including rigid and foamed materials. The plates of the present invention may be used as a building block for a fence surrounding a desired location such as a building or other suitable location.

It is appreciated that different segments within fence 32 may be formed in different colors. Plates 10 and beams 18 and 20 may be connected by any suitable method, such as by welding or by use of screws or nails. Similarly, connector beam 17 and bottom beam 18 or top beam 20 may be connected by any suitable method, such as by welding or by use of screws or nails.

It is appreciated that the provision of a plastic fence plate 10 ensures that the fence is durable, does not rot, and is highly resistant to chemicals and humidity. Additionally, such a fence plate is termite free, and is easy to install.

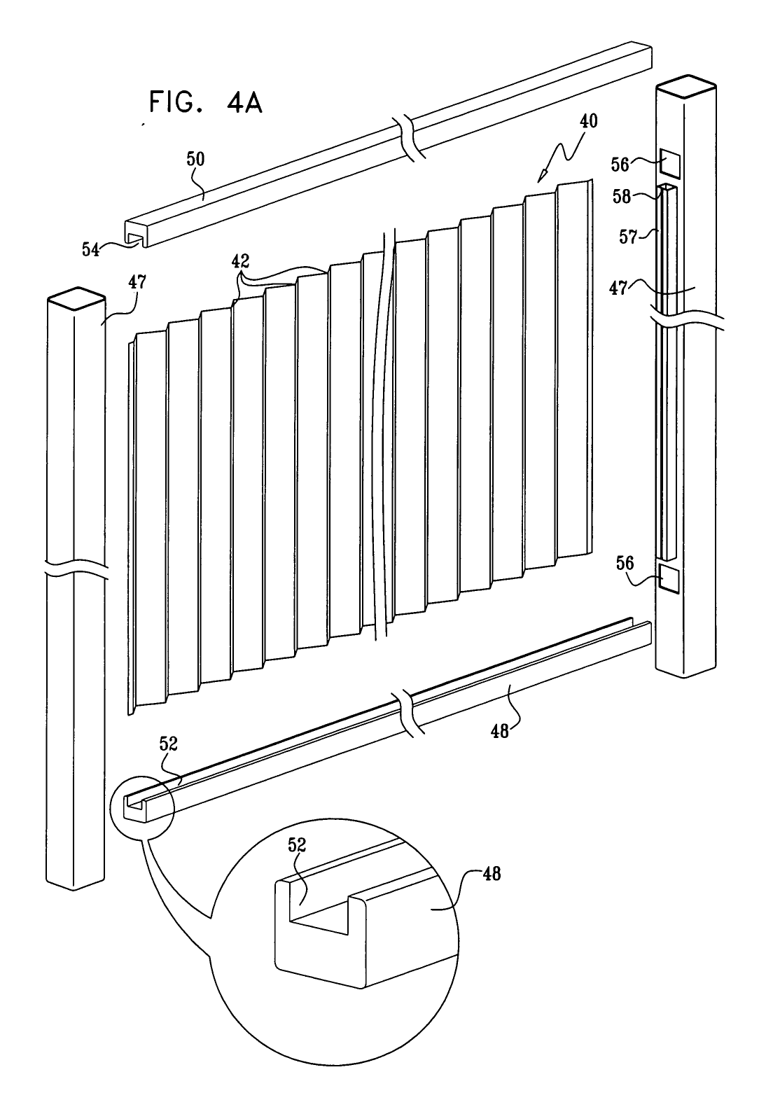

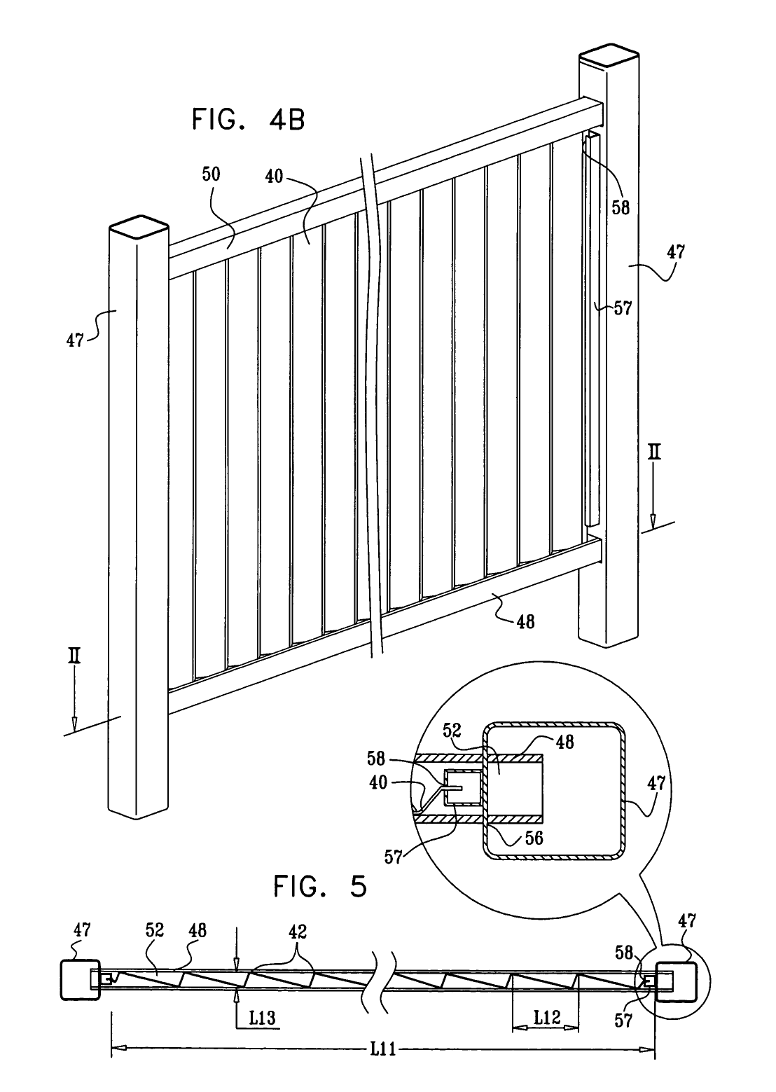

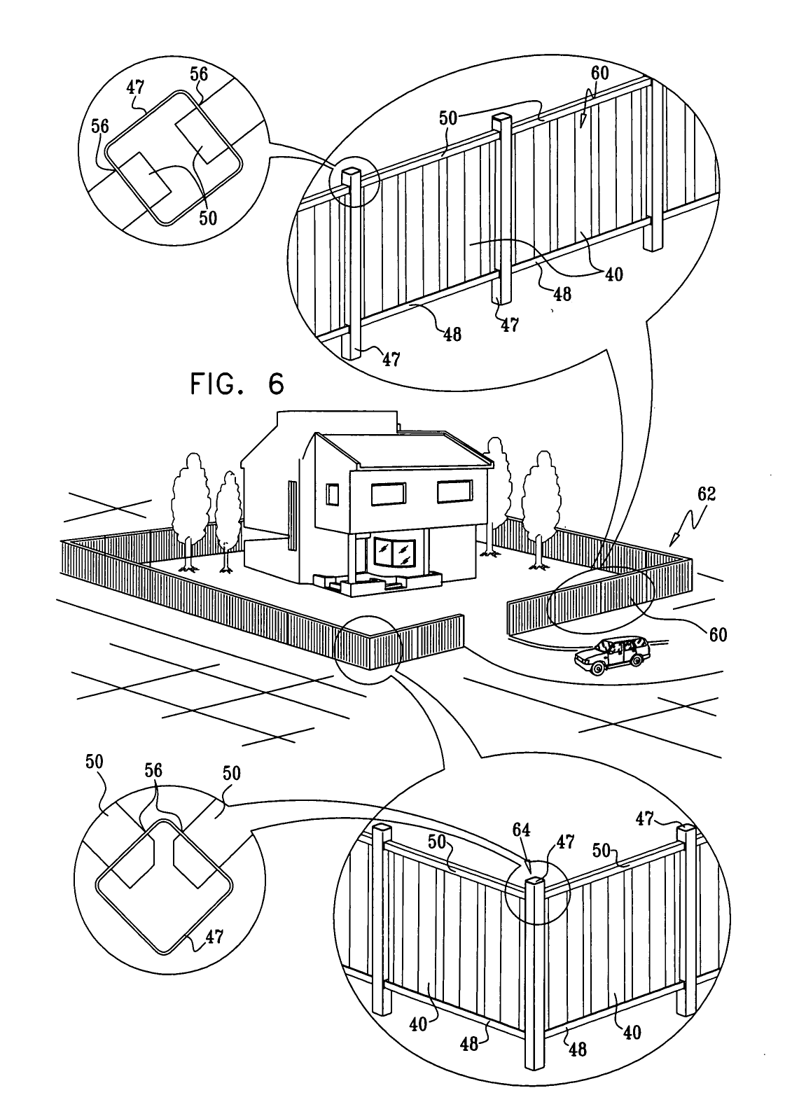

Reference is now made to FIGS. 4A and 4B, which are a simplified exploded view illustration and a pictorial illustration of a single fence plate, constructed and operative in accordance with another preferred embodiment of the present invention, framed by a fence frame thereby to form a fence panel, to FIG. 5, which is a sectional illustration of the panel of FIGS. 4A and 4B, and to FIG. 6, which is a pictorial illustration of a fence constructed of a plurality of the panels of FIGS. 4A-5.

As seen in FIGS. 4A-6, an integrally formed fence plate 40, preferably formed of a single layer of corrugated PVC, is formed with a plurality of teeth 42, thereby providing a serrated look. Alternatively, the fence plate 40 may be formed of polycarbonate or any other suitable plastic material.

The fence plate 40 is preferably surrounded by a fence frame formed of a plurality of beams which provide strength to the fence. The beams may be solid or hollow, and may be square, or formed in any other suitable polygonal shape.

The fence frame is preferably formed of two connector beams 47, a base beam 48 and a top beam 50 all made of PVC, such as a frame of fence model no. 20972 commercially available from U.S. Fence Inc. of Ohio USA. Alternatively, the connector beams 47, base beam 48 and top beam 50 may be formed of wood, metal, or any other suitable material.

As seen with particular clarity in FIG. 4A, base beam 48 includes a longitudinal groove 52 into which is seated a bottom side of the plate 40, in the sense of FIGS. 4A and 4B, and top beam 50 includes a longitudinal groove 54 which is mounted onto the top side of the plate 40, in the sense of FIGS. 4A and 4B. Each of the connector beams 47 includes one or more bores 56, which engage beams 48 and 50. Preferably, each connector beam 47 includes two bores 56, intermediate which is formed an elongate panel mount 57 including a notch 58, which engages one vertical side of plate 40, in the sense of FIGS. 4A and 4B.

FIG. 5 shows that each plate 40 is preferably of a length designated by L11, which is typically in the range of 3-6 feet, has a distance between teeth 42 designated by L12, which is typically in the range of 6-7 inches, and has a profile height designated by L13, which is typically in the range of half an inch to one and a half inches. Preferably, the height of each plate 10 lies in the range of 1 to 20 feet and the ratio between the height and width of each plate 10 is less than 2:1.

As seen in FIG. 6, a single connector beam 47 may be used to connect two or more plates 40, each mounted within panel mounts 57 onto bottom beam 48 and having mounted thereon top beam 50. The top and bottom beams are placed in bores 56 at various angles. FIG. 6 shows the connection between connector beam 47 and two plates 40 along a wall 60 of a fence 62 formed around a building, as well as the connection between connector beam 47 and two plates 40 at a corner 64 of fence 62.

It is appreciated that the fence may be formed in any suitable color or of any suitable material, including rigid and foamed materials. The plates of the present invention may be used as a building block for a fence surrounding a desired location such as a building or other suitable location.

It is appreciated that different segments within fence 62 may be formed in different colors. Plates 40 and beams 48 and 50 may be connected by any suitable method, such as by welding or by use of screws or nails. Similarly, connector beam 47 and bottom beam 48 or top beam 50 may be connected by any suitable method, such as by welding or by use of screws or nails.

It is appreciated that the provision of a plastic fence plate 40 ensures that the fence is durable, does not rot, and is highly resistant to chemicals and humidity. Additionally, such a fence plate is termite free, and is easy to install.

It will be appreciated by persons skilled in the art that the present invention is not limited by what has been particularly shown and described hereinabove. Rather the scope of the present invention includes both combinations and sub-combinations of various features described and shown herein and modifications and variations thereof which are not known in the prior art.

1. A fence comprising:
a plurality of corrugated plastic, integrally formed fence panels; and
a plurality of rectangular frames, each surrounding a corresponding single one of said plurality of fence panels.

2. A fence according to claim 1, and wherein each of said fence panels has a width dimension in the range of 3 to 6 feet.

3. A fence according to claim 1, and wherein each of said fence panels has a height dimension in the range of 1 to 20 feet.

4. A fence according to claim 2, and wherein each of said fence panels has a height dimension in the range of 1 to 20 feet.

5. A fence according to claim 1, and wherein each of said fence panels has a width dimension and a height dimension, a ratio of said height dimension and said width dimension being less than 2:1.

6. A fence according to claim 1, and wherein each of said frames includes at least one elongate panel mount.
